(19) United States
(12) Patent Application Publication
(10) Pub. No.: US 2004/0029448 A1
(43) Pub. Date: Feb. 12, 2004

(54) Adapter

(76) Inventor: Thomas Gavin Melia, Pinehurst, NC (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/637,292

(22) Filed: Aug. 8, 2003

Related U.S. Application Data
(60) Provisional application No. 60/402,440, filed on Aug. 9, 2002.

(51) Int. Cl. H01R 25/00

(52) U.S. Cl. 439/642

(57) ABSTRACT

An electrical adapter to control a light source. The adapter includes a housing having a male connection at one end and a female connection at another end, wherein the male connection is configured to connect with a light socket and the female connection is configured to connect with a light source. A circuit within the housing is provided for controlling the light source. Preferably, the circuit uses one of a random and a preprogrammed set of cycles to control the light source.

### CROSS REFERENCE TO RELATED APPLICATIONS

This application claims benefit of U.S. Provisional Serial No. 60/402,440 filed on Aug. 9, 2002 entitled “ADAPTER.”

### BACKGROUND OF THE INVENTION

The present invention relates to an electrical adapter. In particular, the invention relates to methods and other accommodations to an electrical adapter associated with controlling a light source.

Controlling the lighting system of a home or office while the user is away is important for security reasons. When the user is away, it is important that the lights turn on and off in a pattern to simulate an occupied place in order to deter intruders. As such, controlling the lights in a pattern is extremely important. Presently available timers, present different mechanisms to turn on and off lamps. Commonly, the user will plug the lamp into a timer and, in turn, plug the timer into the wall outlet. Thus, the timer, which is separate from the light bulb, controls the electricity to the light bulb.

A problem with controlling light bulbs with these timers, however, is that these timers can only be used for plug-in lamps. Accordingly, lights, such as but not limited to, ceiling lights, floor lights, overhead lights and track-lighting cannot use the typical plugin timer since these type of lights are controlled by the wall switch. For such lighting systems, timers are presently available that can be hardwired into the wall box in place of the switch. A problem with these types of timers, however, is the inconvenience of installation.

Other light timers, presently available, use a photo-detector to imitate control of a circuit. The bulb turns ON at dusk and OFF at dawn. Other timers use a countdown cycle wherein at the end of the cycle, the bulb turns OFF. A problem with these types of products is that the products employ the dusk/dawn functions and/or the countdown function. Accordingly, a burglar could monitor the control of the lights and corresponding hours to determine the pattern and determine the user is not occupying the room. Thus, a problem with these products is that the products do not employ random or pre-set switching to simulate an occupied room. Additionally, these products contain a slide switch which inconveniently requires the user to physically touch the product in order to change the operating mode.

A need therefore exists for a light adapter which controls the light to simulate a room is occupied. The solution, however, must to adaptable to all light sockets such as ceiling lights and lamps. A need also exists for a light adapter that does not require any additional hardwire, wiring and/or switches. The solution must also be easily manipulated into a light socket while also be activated by a switch. Still, further a need exists for a light adapter that uses a signal receiver, such as a photo-detector, to assist in controlling the light adapter. The solution, however, must also configure the adapter to employ random and/or pre-set patterns.

Aspects of the present invention reside in an adapter device that controls a light source. An advantage of the present invention is to provide an adapter that controls a light source. Another advantage of the present invention is to provide an adapter that can connect to a variety of sockets. Another advantage of the present invention is to provide an adapter that is activated by an existing switch. Another advantage of the present invention is to provide an adapter that employs random and/or pre-set patterns to the light switch. Still further advantages will become apparent from a consideration of the following descriptions and drawings.

### BRIEF DESCRIPTION OF THE DRAWINGS

FIG. 1 is a front view of an adapter device embodying the principles of the present invention.

FIG. 2 is a perspective view of the adapter.

FIG. 3 is a top view of the adapter.

FIG. 4 is a front view of the adapter during use.

FIG. 5 is a view of the adapter during use.

FIG. 6 is a schematic view of portions of the present invention.

### DETAILED DESCRIPTION OF THE PREFERRED EMBODIMENTS

As discussed above, the present invention provides structures and other accommodations to an adapter. The present invention efficiently and conveniently controls a light source.

Aspects of the invention may reside in a light apparatus. The present invention provides a light adapter which controls the light to simulate a room is occupied. The present invention is adaptable to all light sockets such as ceiling lights and lamps without requiring require any additional hardwire, wiring and/or switches. The present invention is also easily manipulated into a light socket while being activated by a switch. In an embodiment, the present invention uses a sensor, such as a photo-detector, to assist in controlling the light adapter. Additionally, the present invention employs random and/or preset patters.

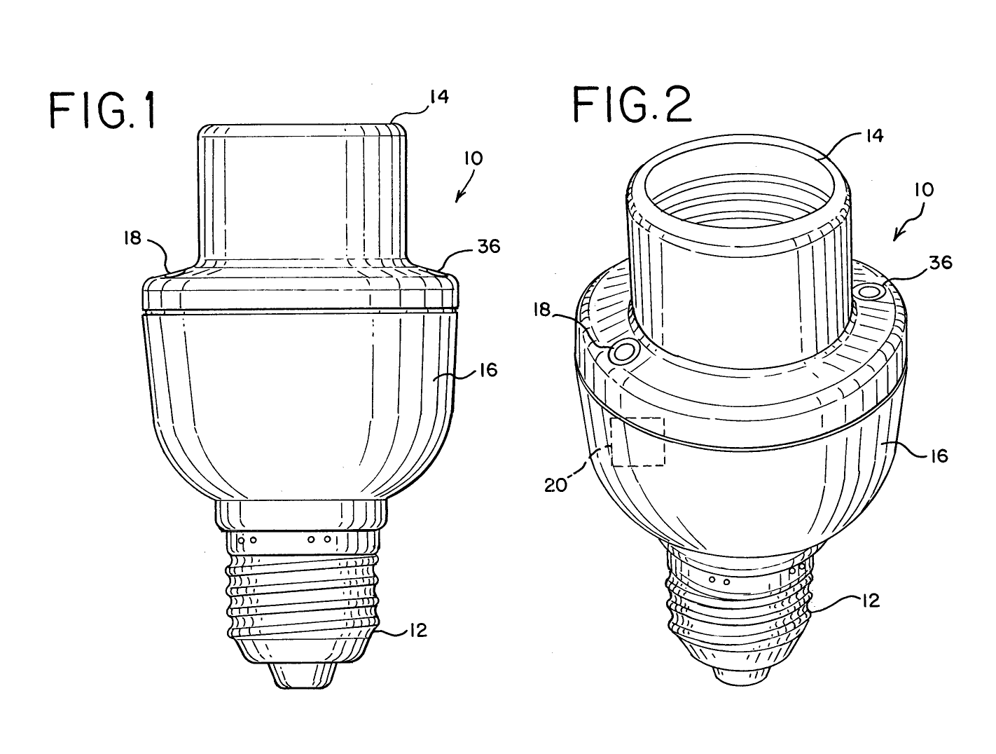

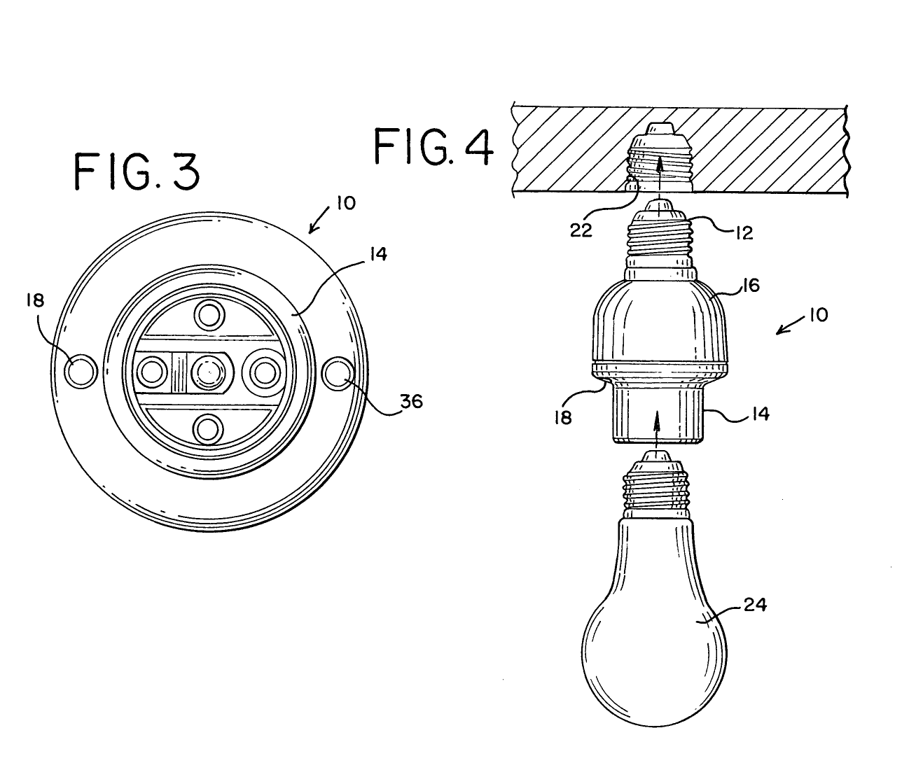

As shown in FIG. 1, the adapter 10 comprises an end 12, another end 14 and a housing 16 positioned between the end 12 and other end 14. As shown, the end 12 may include a male connection which the other end 14 may include a female connection.

Turning to FIG. 2, the adapter 10 further comprises a sensor 18. The sensor 18 may include a photo-detector. The sensor 18 may also include signal receivers, such as but not limited to, infrared detection, motion detection, sound detection and transmitters and receivers.

Further, as shown in FIG. 2, the adapter 10 comprises a circuit 20 usually positioned within the housing 16. The circuit 20 communicates with the sensor 18, the end 12, the other end 14, a power source and a switch 30 as will be discussed.

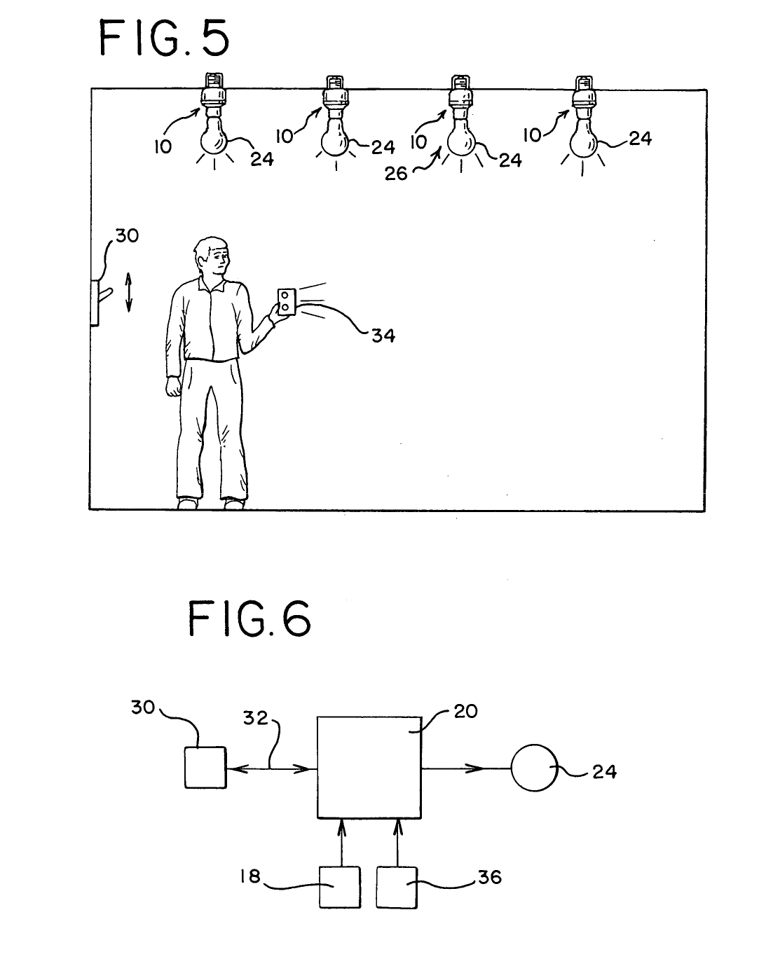

Turning to FIG. 4, the end 12 is confirmed to connect with a socket 22. Additionally, the other end 14 is configured to connect with a light source 24 such as a light bulb. An embodiment of the adapter 12 may reside in connecting with a light system 26 as shown in FIG. 5. An embodiment of the adapter 10 may reside in connecting with a lamp. Returning to FIG. 5, the adapter 10 connects with the light system 26 which is typically powered by a switch 30. In another embodiment, the adapter 10 is powered by the lamp.

During use as shown in FIGS. 4-6, the light source 24 is disconnected from the light system 26. Next, the light source 24 is connected to the other end 14 while the end 12 is connected to the light system 26 via the socket 22. In an embodiment, connecting the components may utilize male and female threads. Other embodiments, however, may utilize plugs.

The user then activates a sequence with the switch 30. The sequence may include turning the switch 30 ON and OFF a number of times for a time interval. For example, the switch 30 may turned ON to OFF to ON again within one second. Once the switch 30 has been sequenced, the circuit 20 receives the sequence to activate the preprogrammed or random security program to control the light source 24.

Once activated by the switch 30, the circuit 20 waits to receive a signal 32 from the sensor 18. The sensor 18, in turn, sends the signal 32 upon receiving a certain criteria level. For example, the sensor 18 may be configured to receive criteria such as the ambient light level. For an embodiment, the sensor 18 uses a photo-detector to monitor the criteria such as that a certain light level has been achieved. The sensor 18 then sends the signal 32 to the circuit 20.

Once the signal 32 is received by the circuit 20 from the sensor 18, the circuit 20 does not process anymore signals from the sensor 18 for a predetermined time. Next the circuit 20 initiates, via a relay or any other type of switch, opening and closing of the power from the switch 30. Accordingly, the circuit 20 directs the relay to turn the light source 24 on and off in a random or preset pattern. The circuit 20 may use a timer to determine the shutoff time of the pattern.

Once the circuit 20 turns off the light source 24 at the shutoff time, the light source 24 will remain off for a predetermined, unspecified, or random period of time. In another embodiment, the light source 24 will remain off until the circuit 20 receives another signal from the sensor 18.

Thus, aspects of the present invention may reside in the circuit 20 being programmed with random or set pattern wherein the circuit 20 is activated by the switch 30. Thus, the mode of the adapter 10 may be controlled by a combination of ON/OFF switching by the wall or lamp switch. The circuit 20 then receives a signal 32 from the sensor 18 to initiate the pattern over a period of time such as six hours. After the period of time, the circuit 20 terminates the pattern and will initiate again upon another signal by the sensor 18 or after another period of time. Accordingly, multiple time periods, such as days, may be used by the adapter 10 to control the light source 24 to simulate an occupied room.

Further, the adapter 10 may turn off by turning off the switch 30. Accordingly, the light source 24 may be turned ON and OFF again to receive normal operations. If the sequence is activated by the switch 30, the random or pre-set pattern of the adapter 10 is started.

In another embodiment, the circuit 20 may be initiated by a remote control 34 as shown in FIG. 5. Accordingly, in this embodiment, the sequence by the switch 30 is not required; but instead, the remote control 34 sends a command which may be received by another sensor 36, (shown in FIG. 2) or the sensor 18. The other sensor 36, in turn, activates the circuit 20 to start the operation.

Further, in another embodiment, when the adapter 10 is placed in a lamp; the user activates the switch on the lamp in the sequence to power the adapter 10. For example, the sequence may consist of turning the lamp switch in a sequence during a period of time such as ON, OFF, ON within one second. Other sequences and time periods, however, may be used.

Thus, the present inventions provides a convenient adapter 10 which easily connects to a socket 22 while eliminating additional hardwire to the existing light system 26. Additionally, an existing switch 30 activates the adapter 10 wherein the adapter 10 controls the light source 24 in a random or pre-set pattern.

In another embodiment, aspects of the invention may reside in an adapter that functions as a timer. When a user goes on vacation or leaves a room for a period of time, the user wants the lights to turn on and off in a pattern which gives would-be burglars the impression that the room is occupied. The user can choose from a range of plug-in timers to control plug-in lamps. However, the lights the user wants to control are those lights in the ceiling which are typically controlled by a wall switch. There are also timers available which can be hardwired into the wall box in place of the switch. However, installation of this timer is oftentimes not convenient and requires wiring. So, a need exists for a user to just unscrew the light bulb, insert a timer to the socket and then insert the light bulb into the timer. Accordingly, the present invention solves the need and is easy to install and easy to use. It could also be used in plug-in lamps.

There are products available that are “light bulb adapters” and use a photodetector to initiate the control of a circuit, such that a bulb turns on at dusk and off at dawn, and in some cases, a countdown cycle, at the end of which the bulb turns off. However, these products do not employ a random or preset switching cycle as in the present invention to simulate the occupied home. Further, these known items contain a slide switch, which requires that the user physically touch the adapter in order to change the operating mode.

### Installation and Operation of an Embodiment

1. The adaptor will work as a normal bulb socket when it controlled by the wall switch with normal ON/OFF operations.

2. The “security,” “vacation,” or any other type of function will activate only when the wall switch is turned ON to OFF and to ON again within say, 1 second.

3. When 2 above has been done, the IC waits for a signal from the photodetector and related circuitry, to indicate that a certain darkness level (dusk) has been reached.

4. Once this signal is received, the IC then ignores any further signal from the photo-detector and related circuitry and initiates the opening and closing of a circuit (via relay) to turn the bulb on and off in a random or preset “security” pattern lasting say, 6 hours, using a countdown timer to determine the shut-off time.

5. After this time, the bulb will remain off until either:

a. 24 hours has elapsed since the original photo detector signal was received, or

b. after say 12 hours, the IC becomes receptive to signals from the photo-detector and related circuitry again, such that they cycle can resume the following night.

6. To exit the “security” mode, turn the wall switch OFF. The light can be left off or turned on again at the wall to resume normal operations.

7. The specification: 110VAC, 1000W max, suitable for normal tungsten bulbs and energy saving bulbs.

Although the foregoing detailed description of the present invention has been described by reference to various embodiments, and the best mode contemplated for carrying out the prevention invention has been herein shown and described, it will be understood that modifications or variations in the structure and arrangement of these embodiments other than there specifically set forth herein may be achieved by those skilled in the art and that such modifications are to be considered as being within the overall scope of the present invention. Accordingly, the present invention is adapted for multiple shapes, sizes and colors.

1. An electrical adapter comprising:
a housing having a male connection at one end and a female connection at another end, wherein the male connection is configured to connect with a light socket and the female connection is configured to connect with a light source; and
a circuit within the housing for controlling the light source, wherein the circuit uses one of a random and a preprogrammed set of cycles to control the light source.

2. The adapter of claim 1 further comprising a sensor.

3. The adapter of claim 2, wherein the sensor includes one of a photo-detector, an infrared detector, a motion detector, and a sound detector.

4. The adapter of claim 1, wherein the circuit is configured to receive a signal for initiating the circuit from a wall-mounted switch.

5. The adapter of claim 1, further comprising a signal receiver for receiving a signal.

6. The adapter of claim 1, further comprising a signal transmitter for transmitting a signal.

7. The adapter of claim 5, wherein the circuit is configured to receive a signal for initiating the circuit from a remote control.

8. An electrical adapter comprising:
a housing having a male connection at one end and a female connection at another end, wherein the male connected is configured to connect with a light socket and the female connection is configured to connect with a light source; and
a circuit within the housing for controlling the light source, wherein the circuit is configured to receive an electrical signal for initiating the circuit.

9. The adapter of claim 8, wherein the circuit uses one of a random and a preprogrammed set of cycles to control the light source.

10. The adapter of claim 8 further comprising a sensor.

11. The adapter of claim 8, wherein the sensor includes one of a photo detector, an infrared detector, a motion detector, and a sound detector.

12. The adapter of claim 8, wherein the circuit is configured to receive a signal for initiating the circuit from a wall-mounted switch.

13. The adapter of claim 8, wherein the circuit is configured to receive a signal for initiating the circuit from a remote control.

14. A method for operating a light source comprising:
connecting one end of an adapter to a light source and a second end to a light socket; and
transmitting a sequence to the adapter for initiating a circuit within the adapter, wherein the circuit uses one of a random and a preprogrammed set of cycles to control the light source.

15. The method of claim 14, wherein the transmitting of a sequence is performed using a remote control.

16. The method of claim 14, wherein the transmitting of a sequence is performed by activating a wall-mounted switch.

17. The method of claim 14, further comprising receiving a signal in the adapter from a sensor connected with the adapter.

18. A method for operating a light source comprising:
initiating a circuit within an adapter upon receiving a signal, wherein one end of the adapter is connected to a light source and a second end is connected to a socket; and
controlling the light source with the circuit.

19. The method of claim 18, wherein the circuit uses one of a random and a preprogrammed set of cycles to control the light source.

20. The method of claim 18, further comprising receiving a signal from a sensor connected with the adapter.
